(19) United States
(12) Patent Application Publication
(10) Pub. No.: US 2026/0051095 A1
(43) Pub. Date: Feb. 19, 2026

(54) SYSTEM AND METHOD FOR GENERATIVE ARTIFICIAL INTELLIGENCE BASED IMAGE GENERATION

(71) Applicant: ACCENTURE GLOBAL SOLUTIONS LIMITED, Dublin (IE)

(72) Inventors: King Binghao TANG, Shenzhen (CN); Nan KE, Xiamen (CN); Wenjun LUO, Shenzhen (CN)

(73) Assignee: ACCENTURE GLOBAL SOLUTIONS LIMITED, Dublin (IE)

(21) Appl. No.: 19/297,884

(22) Filed: Aug. 12, 2025

(30) Foreign Application Priority Data
Aug. 16, 2024 (CN) 202411128447.7

(51) Int. Cl. G06T 11/60; G06F 40/40; G06T 7/11; G06T 7/50

(52) U.S. Cl. CPC G06T 11/60; G06F 40/40; G06T 7/11; G06T 7/50

(57) ABSTRACT

System and method for Generative Artificial Intelligence based image generation are disclosed. In an aspect, a user input is received requesting an image of a predetermined object to be generated. An enhanced prompt is then generated from the user input, the enhanced prompt includes one or more of a reference image of the predetermined object and a textual portion describing technical details for generating the image. Further, the enhanced prompt is input to an image generation model that preserves portions of the reference image including the predetermined object unchanged via masking the portions of the reference image, generates a depth map of the reference image, and generates an intermediate image by merging the reference image with the masked portions of the predetermined object and the depth map. Also, an enhanced version of the intermediate image is output as the image generated in response to the user input.

### CROSS-REFERENCE TO RELATED APPLICATION(S)

This application claims priority under 35 USC § 119(a) to China Provisional Application No 202411128447.7, filed on Aug. 16, 2024, the entire content of which is hereby incorporated by reference in the entirety for all purposes.

### TECHNICAL FIELD

Various examples described herein relate generally to a method and system for image generation. Specifically, the disclosed examples are directed to techniques for Generative Artificial Intelligence (Gen AI)-based image generation.

### BACKGROUND

Image generation using Artificial Intelligence (AI) has advanced significantly in recent years, enabling users to create high-quality images through textual prompts. The existing systems rely on large-scale diffusion models or transformer-based architectures and are widely used in domains such as marketing, content creation, product design, and visual storytelling. However, despite their capabilities, the existing systems have limitations including the need for complex prompt engineering, inability to generate untrained elements, and lack of precise control over object positioning and visual details. These limitations may hinder usability, creativity, and accuracy in real-world applications.

### SUMMARY

Implementations of the present disclosure are generally directed to image generation. More particularly, implementations of the present disclosure are directed to techniques for Generative Artificial Intelligence (Gen AI)-based image generation.

In some examples, aspects of the subject matter described herein provide a processor-executable method for Gen AI-based image generation. The method may include receiving, by a processor, a user input requesting an image of a predetermined object to be generated. Further, the method includes generating, by the processor, via a multimodal prompt generating model, an enhanced prompt from the user input. The enhanced prompt includes one or more of a reference image of the predetermined object and a textual portion describing technical details for generating the image. Furthermore, the method includes inputting, by the processor, the enhanced prompt to an image generation model that preserves portions of the reference image including the predetermined object unchanged via masking the portions of the reference image, generates a depth map of the reference image and generates an intermediate image by merging the reference image with the masked portions of the predetermined object and the depth map. The depth map enables positioning of the predetermined object in the image to be generated. Moreover, the method includes outputting, by the processor, an enhanced version of the intermediate image as the image generated in response to the user input.

The present disclosure further describes a Gen AI-based image generation system for implementing the method provided herein. The present disclosure also describes a non-transitory processor-readable storage medium including processor-readable instructions that cause a processor to perform operations in accordance with the method described herein.

It is appreciated that the method in accordance with the present disclosure can include any combination of the aspects and features described herein. That is, the method in accordance with the present disclosure is not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment that may be used to execute implementations of the present disclosure.

FIG. 2 depicts an example architecture of a Generative Artificial Intelligence (Gen AI)-based image generation system, in accordance with implementations of the present disclosure.

FIG. 3 depicts an example flow diagram illustrating a method of generating enhanced prompts, in accordance with implementations of the present disclosure.

FIG. 4 depicts an example flow diagram illustrating a process of building prompt templates, in accordance with implementations of the present disclosure.

FIG. 5 depicts an example flow diagram illustrating a method of changing background of a reference image, in accordance with implementations of the present disclosure.

FIG. 6 depicts an example diagram illustrating an image-to-image generation after denoising, in accordance with implementations of the present disclosure.

FIG. 7 depicts an example diagram illustrating an image generated using the system of FIG. 2, in accordance with implementations of the present disclosure.

FIG. 8 is a flow diagram that represents an example method for the Gen AI-based image generation, in accordance with implementations of the present disclosure.

FIG. 9 depicts a block diagram of an example computer system that may be used to implement the method for the Gen AI-based image generation, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., re labels to distinguish components or blocks of otherwise similar names but does not imply any sequence or numerical limitation.

“And/or” for two possibilities means either or both stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

Generative Artificial Intelligence (GenAI) systems for image synthesis have advanced considerably, enabling users to create detailed visual content from textual prompts. However, existing systems present significant technical limitations that impede their broader utility, especially in professional and enterprise use cases where control, accuracy, and creative flexibility are critical.

For example, the existing systems may require users to construct detailed and highly specific prompts that deviate from natural language. This often demands familiarity with model-specific terminology, stylistic descriptors, or compositional cues. Users who lack expertise in prompt engineering may face difficulty translating abstract concepts, brand design guidelines, or visual instructions into effective prompts, resulting in low-quality or inconsistent outputs.

Furthermore, as existing GenAI models are trained on pre-existing datasets, they exhibit poor performance when tasked with creating visual elements or styles not represented in their training data. As a result, such models fail to support fully customized or innovative design requirements.

Also, when reference images are supplied, the existing systems struggle to maintain the integrity and detailed features of those references, often leading to distortion, misplacement, or style mismatches. This lack of precision prevents the effective use in scenarios requiring strict layout adherence, such as advertisement creatives, brand collateral, or technical mockups. Therefore, the above demonstrate the need for improved systems and methods that enhance prompt interpretability, support generation of unseen visual content, and enable accurate positioning and representation of reference objects within generated images.

Implementations of the present disclosure may provide systems and methods relates to a generative artificial intelligence (Gen AI)-based image generation system that creates high-quality, layout-consistent images by leveraging advanced prompt engineering, controlled image generation, and optional model fine-tuning. Thus, the present disclosure addresses key challenges in conventional Gen AI workflows, including prompt complexity, inability to generate out-of-distribution elements, and difficulty in preserving object integrity and spatial positioning.

Implementations of the present disclosure provide multi-aspect prompt enhancement to improve the quality, consistency, and relevance of image generation outputs. The Gen AI-based system leverages a Large Language Model (LLM) in conjunction with a structured prompt enhancement database to transform user-provided ideas into enriched prompts. By abstracting the complexity of prompt engineering, the system enables users to generate high-quality concept images with minimal input. This significantly lowers the barrier to creative exploration and accelerates the ideation process. Furthermore, the enhanced prompt formulation reduces the likelihood of generating unrealistic or semantically inconsistent images by aligning the prompt structure and content with model expectations.

The Gen AI-based system further enables controlled integration of subjects or products into diverse backgrounds. The Gen AI-based system incorporates computer vision techniques, such as object segmentation and depth map estimation to generate masks and spatial metadata for the input images. These masks are used during the image generation process to preserve the position, structure, and visual integrity of selected foreground objects, such as a human figure or a product, while regenerating or modifying the background. This facilitates seamless compositing of new scenes without distorting fixed elements. The Gen AI-based system is particularly advantageous in use cases requiring deterministic control, such as e-commerce poster design, where consistent product presentation with varying backdrops is essential.

Additionally, the Gen AI system supports controlled image generation using client-specific data, allowing customization of generated outputs to conform to branding guidelines and other stylistic constraints. Through advanced prompt enhancement and lightweight model adaptation techniques (e.g., low-rank adaptation), the Gen AI-based system is capable of aligning generated content with predefined brand identities or campaign-specific visual themes. This dual capability of creative freedom and compliance is especially valuable in domains such as digital marketing, interior design, and content production.

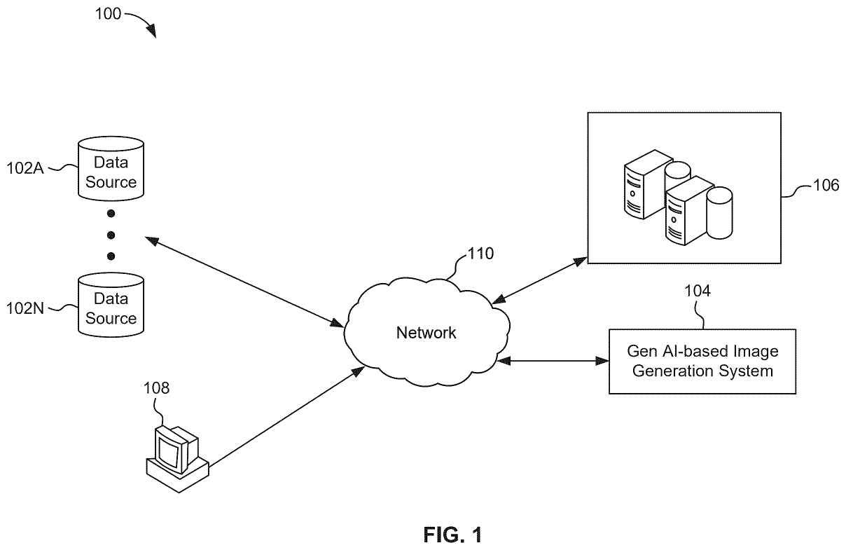

FIG. 1 depicts an example environment 100 that may be used to execute implementations of the present disclosure. The example environment 100, shown in FIG. 1, includes data sources 102A-N, a Gen AI-based image generation system 104, a storage device 106 and a user device 108. For simplicity, a single user device 108 is depicted in FIG. 1, however it should be noted that the example environment 100 may include one or more user devices. The data sources 102A-N, the Gen AI-based image generation system 104, the storage device 106 and the user device 108 may communicate with each other using a network 110. In some examples, the network 110 may include a Local Area Network (LAN), a Wide Area Network (WAN), the Internet, or a combination thereof. In some examples, the network 110 may be accessed over a wired and/or a wireless communication link.

The plurality of data sources 102A-N may include communication devices and/or computing devices that includes data associated with reference images. The plurality of data sources 102A-N may include a server such as a web server, a database server, a host server, a proxy server, a virtual server (e.g., executing on a computing hardware), or a server in a cloud computing system.

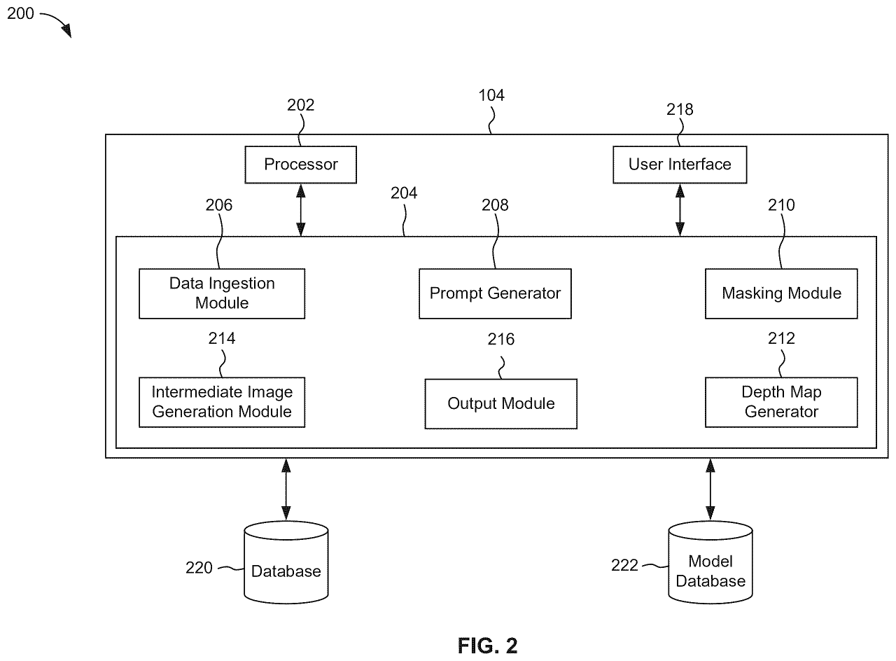

The Gen AI-based image generation system 104 is a computing device or an application server that receives or obtains the data from the plurality of data sources 102A-N to process a user input. The Gen AI-based image generation system 104 may then process and store an enhanced image in response to the user input in the storage device 106. In some examples, the Gen AI-based image generation system 104 may include internal or external servers, quantum computers, desktops, laptops, smartphones, tablets, and/or the like. It is contemplated that implementations of the present disclosure may be realized with any appropriate type of computing device or computing platform. In some examples, the Gen AI-based image generation system 104 may display one or more Graphical User Interfaces (GUIs) 218 that enable the user of the user device 108 to interact with a computing platform executing the image generation. Examples of the computing platform may include content delivery platforms, multimedia-based platforms, and/or the like. Interacting with the computing platform may include providing feedback during the process of image generation. For example, the Gen AI-based image generation system 104 is described in more detail with reference to FIG. 2.

While only one Gen AI-based image generation system 104 is shown in FIG. 1, there may be more than one Gen AI-based image generation system 104, and each of the Gen AI-based image generation system 104 includes at least one server system. In some examples, the system hosts one or more computer implemented services that users can interact with by using the user device 108. For example, components of enterprise systems and applications can be hosted on one or more of the Gen AI-based image generation system 104. In some examples, the Gen AI-based image generation system 104 can be provided as an on-premises system that is operated by an enterprise or a third-party taking part in cross-platform interactions and data management. In some examples, the Gen AI-based image generation system 104 can be provided as an off-premises system (e.g., cloud or on-demand) that is operated by an enterprise or a third-party on behalf of an enterprise.

In some examples, the user device 108 may include computer executable applications executed thereon. The user device 108 may include a web browser application executed thereon, which can be used to display one or more web pages of applications executing on the Gen AI-based image generation system 104. In some examples, the user device 108 can display one or more GUIs that enable the respective the users to interact with the Gen AI-based image generation system 104 and/or to present the response generated to the input prompt. In accordance with implementations of the present disclosure, the Gen AI-based image generation system 104 may host enterprise applications or systems that require data sharing and data privacy.

In some implementations, the Gen AI-based image generation system 104 can be implemented in a cloud environment. In the example of FIG. 1, the Gen AI-based image generation system 104 can include various forms of servers including, but not limited to, a web server, a proxy server, a network server, and/or a server pool. In general, server systems accept requests for application services and provide such services to any number of user devices.

Further, the storage device 106 may include any standalone server or any type of computing device that is part of a cloud computing environment for storing data that is ingested by processing the input data. Various examples depicting the image generation are described in detail in conjunction with FIGS. 2-8.

FIG. 2 depicts an example architecture 200 of the Gen AI-based image generation system 104, in accordance with implementations of the present disclosure. As depicted in FIG. 2, the Gen AI-based image generation system 104 is communicatively coupled to a database 220 (e.g., the storage device 106) and a model database 222. For example, the database 220 can be a client database or a metadata database. In some examples, the model database 222 may include one or more LLMs (also referenced herein as Gen AI models, foundation models, and/or the like). In an implementation, the LLMs may include pre-trained LLMs, generated LLMs, multimodal prompt generating models, image generation models, text-to-image generation models and image-to-image generation models. The pre-trained LLMs may be general-purpose Gen AI models like large deep learning neural networks, which may be trained using a broad range of generalized and unlabeled training data to perform one or more tasks, such as, human computer interactions (e.g., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or AI models.

As depicted in FIG. 2, the Gen AI-based image generation system 104 includes a processor 202 and a memory 204. The Gen AI-based image generation system 104 may also include other components such as communication interfaces, Input/Output (I/O) devices, and so on (not shown in FIG. 2). The processor 202 may include one or more processors. Examples of the one or more processors may include, but not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the processor 202 may be programmed to execute computer-readable instructions stored in the memory 204 (also referenced herein as computer-readable storage medium (CRM)) for performing operations according to the present disclosure. The memory 204 may be non-transitory or non-volatile medium, such as a magnetic disk or solid-state non-volatile memory or volatile medium such as Random Access Memory (RAM), and/or the like.

The system 104 further includes a data ingestion module 206, a prompt generator 208, a masking module 210, a depth map generator 212, an intermediate image generation module 214 and an output module 216 as depicted in FIG. 2. The data ingestion module 206, the prompt generator 208, the masking module 210, the depth map generator 212, the intermediate image generation module 214 and the output module 216 may be stored in the memory 204 and provided as a downloadable library including the computer-readable instructions. The data ingestion module 206, the prompt generator 208, the masking module 210, the depth map generator 212, the intermediate image generation module 214 and the output module 216 may be executed by the processor 202 communicatively coupled with the memory 204 for performing Gen AI-based image generation.

In an example implementation, the data ingestion module 206 may receive the user input requesting an image of a predetermined object to be generated. For example, the user input includes one or more of an input image or a reference image and a brief textual description of the image to be generated. Further, the prompt generator 208 may generate via a multimodal prompt generating model, an enhanced prompt from the user input. For example, the enhanced prompt includes one or more of a reference image of the predetermined object and a textual portion describing technical details for generating the image.

In an aspect, to generate the enhanced prompt, the prompt generator 208 may identify a style for the image based on the brief textual description from the user input. Further, the prompt generator 208 may retrieve one or more prompt templates with style tags matching the style from a database of prompt templates. For example, the one or more prompt templates include the technical details for the image generation. The details included in the prompt templates may include one or more technical details of the image. Also, the prompt generator 208 may generate the textual portion of the enhanced prompt by adding the technical details to the brief textual description received in the user input.

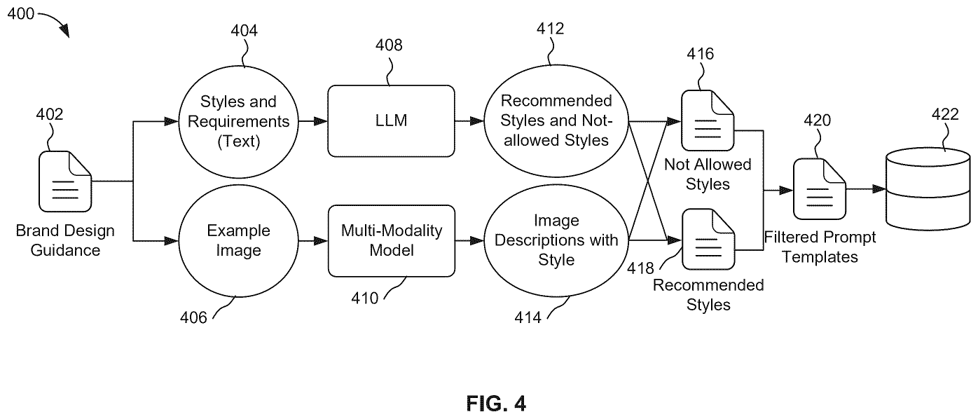

In an example implementation, to retrieve the one or more prompt templates, the prompt generator 208 may access a database of prompt templates and content rules specifying allowed styles and disallowed styles. Further, the prompt generator 208 may filter the prompt templates of the database based on the allowed styles and disallowed styles to retrieve the one or more prompt templates. The process of retrieving the one or more prompt templates is explained in more detail with reference to FIG. 4.

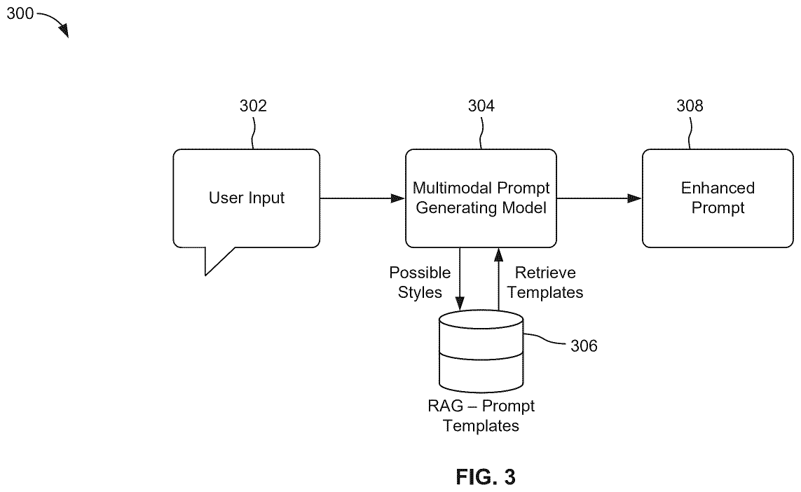

In some examples, to generate the enhanced prompt, the prompt generator 208 may provide the input image to the multimodal prompt generating model and receive a textual description of the input image as output from the prompt generating model when the user input includes the input image. The process of generating an enhanced prompt is explained in more detail with reference to FIG. 3.

Furthermore, the masking module 210 may input the enhanced prompt to an image generation model that preserves portions of the reference image including the predetermined object, unchanged via masking the portions of the reference image. In addition, the depth map generator 212, using the image generation model, may generate a depth map of the reference image that positions the predetermined object in the image to be generated. In an example implementation, the image generation model includes a segmentation model that masks the portions of the reference image including the predetermined object. Also, the image generation model includes a depth estimation model that generates the depth map of the reference image. For example, the depth map may provide a layout for positioning the predetermined object in the image to be generated.

In some examples, the image generation model is trained by freezing pre-trained model weights of parameters of the image generation model. Further, trainable rank decomposition weights are injected into each layer of a transformer of the image generation model.

Moreover, the intermediate image generation module 214 may generate an intermediate image by merging the masked portions of the predetermined object and the depth map. In some examples, to generate the intermediate image, the intermediate image generation module 214 may input the depth map to a control network included in the image generation model. The control network positions the predetermined object in the image by guiding image generation along the layout provided by the depth map.

In an aspect, to generate the intermediate image, the intermediate image generation module 214 may receive a preliminary image of the predetermined object in the user input. Further, the intermediate image generation module 214 may generate the intermediate image with a background from the reference image superimposed with the preliminary image of the predetermined object in a foreground.

Also, the output module 216 may output an enhanced version of the intermediate image as the image generated in response to the user input. In some examples, to output the enhanced version of the intermediate image, the output module 216 may provide output of the control network and the reference image with the masked portions to an image-to-image generation model within the image generation model. For example, the control network is a neural network architecture to add spatial conditioning controls to large, pretrained text-to-image diffusion models. The control network locks the production-ready large diffusion models, and reuses their deep and robust encoding layers pretrained with billions of images as a strong backbone to learn a diverse set of conditional controls. The neural architecture is connected with zero convolutions (zero-initialized convolution layers) that progressively grow the parameters from zero and ensure that no harmful noise could affect the finetuning.

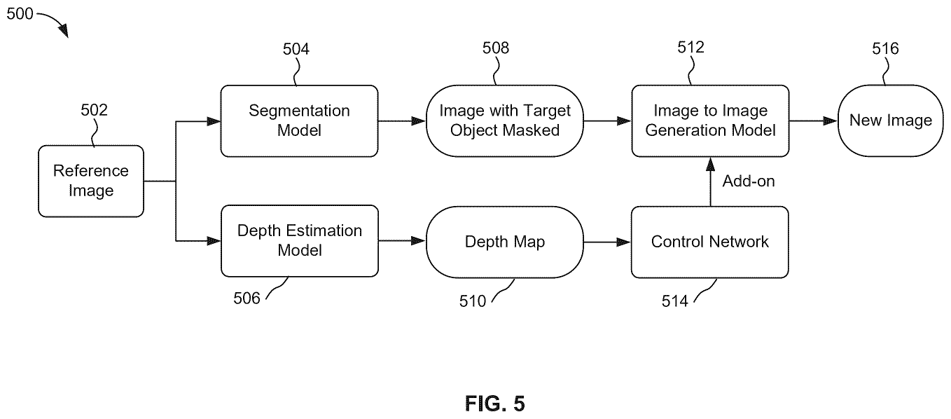

Further, the output module 216 may execute the image-to-image generation model that adds noise to the reference image. In an aspect, the mask is used to keep the area unchanged during the denoising (generation) process. In an aspect, the output module 216 may enhance an output from the image-to-image generation model by adding shadows. Also, the output module 216 may provide the enhanced version of the intermediate image with the shadows as the image generated in response to the user input. In an aspect, the image generation process is a denoising process that converts noise to clean the image. Upon receiving an image without shadows, the image-to-image generation model may generate the shadows by adding a little noise to the image or by denoising the area that should have a shadow. For example, the denoising process uses a text input and/or a layout input from the depth map to generate the image with the shadows. The process of generating the enhanced version of the intermediate image is explained in more detail with reference to FIG. 5.

Referring now to FIG. 3 that depicts an example flow diagram illustrating a method 300 of generating enhanced prompts, in accordance with implementations of the present disclosure. Particularly, FIG. 3 illustrates the method 300 for generating an enhanced image generation prompt (i.e. the enhanced prompt) from a user-provided input using a combination of a multimodal prompt generating model (i.e., a Large Language Model (LLM)) and a Retrieval-Augmented Generation (RAG) framework.

In an example implementation, a user input 302 (e.g., a multilingual input) is received. The user input 302 include may be an input or reference image and/or brief textual description of the image. For example, the user input 302 may include brief textual description as “a relaxing living room with soft colors and Scandinavian design”. Further, the user input 302 is converted into a formal textual description of the image to be generated (i.e., a desired image) using the multimodal prompt generating model 304. The formal textual description may include concrete elements, such as objects (e.g., a wooden coffee table), layout hints (e.g., centered near a large window), and emotional or tonal attributes (e.g., minimalist and cozy). The output ensures the information is detailed enough for a text-to-image generation model to interpret.

Also, a list of probable visual styles are identified using the multimodal prompt generating model 304 based on semantic analysis of the user input 302 (i.e., the brief textual description of the image). For example, the styles may include style tags, such as photorealistic, flat design, watercolor, studio photography, domain-specific tags and the like. The style tags are used for guiding prompt retrieval.

Furthermore, one or more prompt templates with style tags matching the style are retrieved from a database of prompt templates (i.e., a RAG database) 306. Particularly, the styles are used as search keys to query a prompt template database (i.e., the RAG database), which is pre-curated using design guidelines and annotated with style tags (as described in FIG. 4). For example, the one or more retrieved prompt templates may include the technical details, such as prompts for one of formatting, tone, or terminology suitable for the selected style and optimized for specific GenAI models (i.e., the multimodal prompt generating model 304). In some examples, additional filters, such as brand compliance (e.g., avoiding neon colors or cartoonish renderings if such styles are blacklisted by a brand) are applied while retrieving the one or more prompt templates.

In addition, textual portion of an enhanced prompt 308 is generated by adding the technical details to the brief textual description received in the user input 302. In an example implementation, the image or textual description is fused with the retrieved prompt templates by mapping descriptors of each style to the technical vocabulary expected by the text-to-image generation model. Further, in this example implementation, the one or more prompt templates are populated by injecting objects, scenes, emotions, and layout hints into template placeholders and it is ensured that the merged prompt remains stylistically coherent and adheres to syntax constraints of the text-to-image generation model. For example, a raw user input “a cozy living room in Scandinavian style” may be converted into an enhanced prompt as “A wide-angle view of a cozy Scandinavian living room interior, featuring light wood tones, soft textiles, natural lighting, and minimalist furniture. Rendered in high-resolution, photorealistic style, suitable for commercial home design catalogs.” The resulting enhanced prompt serves as a complete and structured instruction set for the text-to-image generation model by considering formatting, styling or content rules, style and layout specificity and the like. In some examples, the prompt may include conditioning elements like negative prompts (to exclude undesired styles), control parameters or rules (e.g., aspect ratio, lighting and the like), or additional metadata tags. Therefore, the process of generating the enhance prompt addresses the challenge of translating vague, high-level user ideas into actionable, structured prompts compatible with Gen AI image models. Also, the user is not required to understand GenAI-specific prompt syntax or formatting.

Referring now to FIG. 4 that depicts an example flow diagram illustrating a process 400 of building the prompt templates, in accordance with implementations of the present disclosure. In an aspect, an input 402 including brand design guidance is received. The brand design guidelines may include textual content 404, such as documents specifying preferred and prohibited image styles (e.g., “Avoid cartoonish images”, “Prefer soft lighting and natural textures” and so on) and example images 406, illustrating both allowed and disallowed styles (e.g., product posters, marketing banners, user interface components).

Further, the textual content or portion 404 of the brand guidance is input to a LLM 408. The text is then analyzed using the LLM 408 to extract recommended or allowed styles and not-allowed or disallowed styles 412. In an aspect, the text content 404 is analyzed to perform named entity recognition of the styles (e.g., photorealistic, sketch, 3D render and the like), rule-based filtering or zero-shot classification to flag disallowed phrases and contextual reasoning (e.g., interpreting “avoid saturated backgrounds” as a constraint on lighting or color palette). Thus, structured labels or style tags that map to style identifiers are determined using the LLM 408.

Furthermore, the example images 406 (i.e., visual portion or input image) is processed using a multi-modality model 410 capable of vision-to-language translation. The multi-modality model 410 may be implemented using a vision encoder that generates image descriptions 414 including object types, composition, tone, lighting, style cues and the like. The image descriptions or captions 414 are passed to a LLM (i.e., a style classifier) to infer whether each image represents a recommended style or a disallowed style. Also, two distinct lists including recommended styles 418 (e.g., realistic, minimalist, warm tone, high-key lighting and the like) and disallowed styles 416 (e.g., cartoon, dark mood, heavy shadows and the like) are generated. The lists may then be formalized into machine-readable format and stored for downstream filtering.

In some examples, a library of one or more prompt templates (e.g., scraped or curated prompts from community models) is retrieved. The prompt templates are labeled with style tags. Each prompt template is associated with one or more style tags (e.g., a prompt containing “cyberpunk” is tagged with “futuristic,” “high contrast,” and “glow effects”).

Further, the tagged styles in each prompt template are compared against the allowed or disallowed styles to filter the prompt templates 420. If a template contains only allowed styles or content rules, then the template is marked as compliant. If the template contains any disallowed style, then the template is excluded or flagged for review. Furthermore, the remaining prompt templates, now tagged, validated, and brand-compliant, are added to a RAG database 422 (i.e., the RAG database 306) in the database 220. The RAG database 306 may serve as a knowledge base for the prompt generation (as explained in FIG. 3) enabling fast retrieval of stylistically aligned prompt templates, controlled image generation consistent with brand standards, extension to new clients by updating style guidance dynamically.

FIG. 5 depicts an example flow diagram illustrating a method 500 of changing background of a reference image, in accordance with implementations of the present disclosure. The Gen AI-based system 104 may be configured to generate images based on a reference image 502 while preserving a predetermined object (e.g., a product or person) and allowing changes to the background or surrounding layout. In an aspect, the reference image 502, which contains at least one target object that must remain unchanged during image generation, is received. The reference image may depict products (e.g., shoes and phones) or people (e.g., a model) that should be retained in the final output (i.e., a new image 516).

Further, an image with masked portions 508 is generated by performing a binary or multi-class mask of a target object in the reference image using a segmentation model 504. The mask identifies a region corresponding to the target object, effectively separating from the background. The mask is utilized to safeguard specific areas, ensuring they remain unchanged during the image generation process. The segmentation model is implemented using transformer-based vision and pretrained weights for general-purpose object segmentation. For example, the segmentation model is a foundation model towards solving prompt able visual segmentation in images and/or videos. The design of the segmentation model is a simple transformer architecture with streaming memory for real-time video processing. Furthermore, the reference image 502 is sent to a depth estimation model 506 to compute a depth map 510, which captures a spatial layout and relative distance of objects in a scene. The depth map helps preserve scene geometry when generating a new background and maintaining realistic object placement.

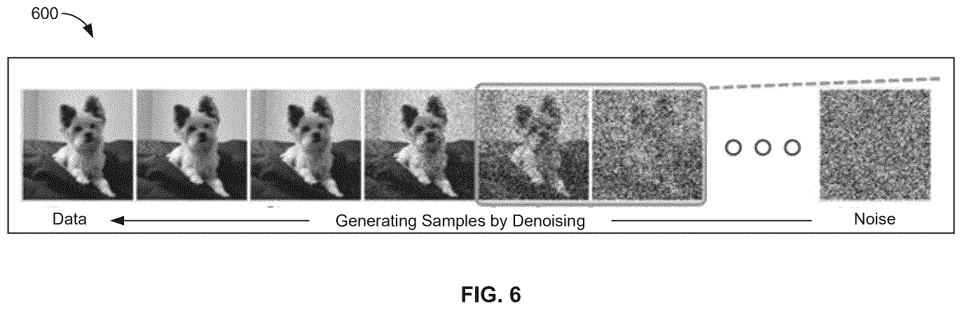

In addition, an image-to-image generation model 512 is initialized by injecting noise (e.g., Gaussian) into the reference image to make the image suitable for image-to-image transformation. The image-to-image generation model, such as a diffusion-based model (e.g., Stable Diffusion with img2img capability), may be used to synthesize a new image. An example image 600 of FIG. 6 depicts image-to-image generation after denoising. For example, the masked image is used to lock an object region, ensuring that the target object remains unchanged during the denoising and regeneration process.

Also, the depth map is input to a control network 514 included in the image generation model to position the predetermined object in the image by guiding image generation along the layout provided by the depth map. For example, the control network 514 is a neural architecture that adds conditioning layers (e.g., zero convolutions) to a frozen image generation model. The control network 514 uses the depth map as a spatial constraint, guiding the model to maintain the same object positioning and layout while enabling stylistic or background changes. Also, the new image 516 is generated by merging the object region from the mask and thee regenerated background, controlled via the enhanced prompt and depth map. The new image thus maintains object integrity (e.g., size, position and appearance), scene realism (e.g., consistent shadows, lighting, depth) and creative variability in style and background. For example, the new image 516 is an image with a harmonized background, maintaining consistency in layout and preserving object fidelity.

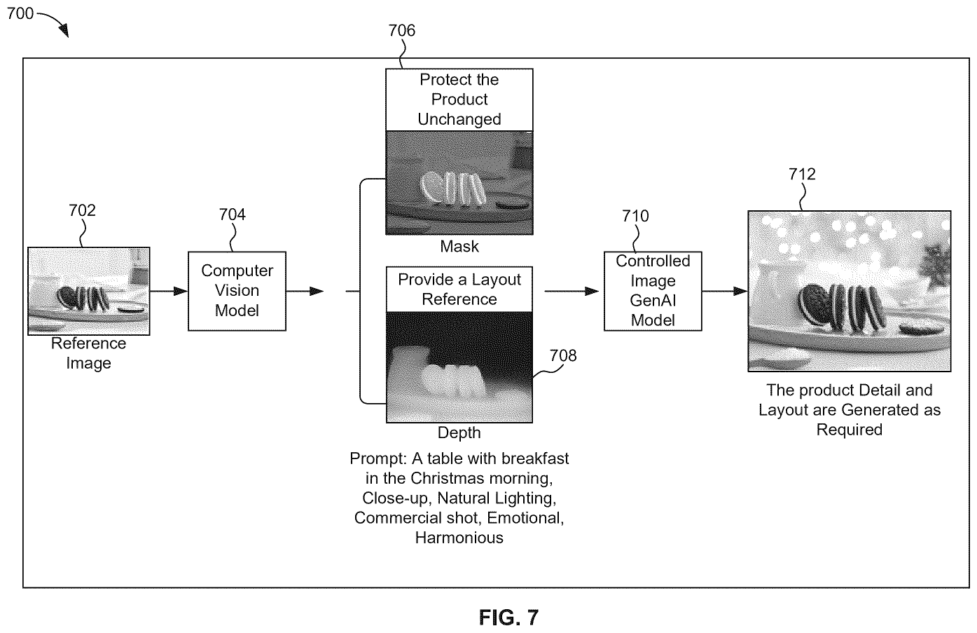

Referring now to FIG. 7 that depicts the process of Gen AI-based image generation by the Gen AI-based system 104. For example, the Gen AI-based system begins with an original image or a reference image 702 that includes a product or object of interest. A computer vision model 704, such as a segmentation model, is applied to generate a mask 706 that isolates and protects the product region, ensuring the product region remains unchanged during the generation process. Simultaneously, a depth map 708 is extracted from the original image 702 to serve as a layout reference, guiding the spatial arrangement of the scene. A user-defined prompt (e.g., “A table with breakfast on Christmas morning, close-up, natural lighting, commercial shot, emotional, harmonious”) is then processed along with the protected product region and depth information by a controlled image Gen AI model 710, such as a diffusion-based model enhanced with a control network. The model 710 generates a new image 712 where the product detail and layout are preserved, while the background and surrounding elements are rendered in accordance with the prompt, achieving stylistic harmony and spatial realism. Thus, demonstrates the system 104 ability to generate visuals that maintain object integrity while enabling creative background variation.

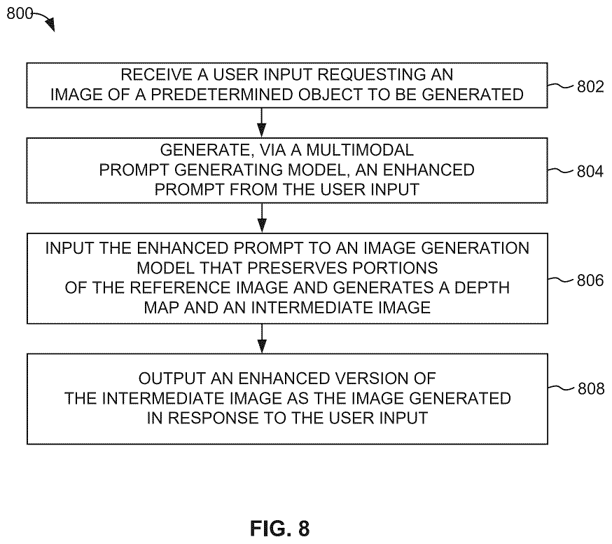

FIG. 8 is a flow diagram that represents an example computer-implemented method 800 for, in accordance with implementations of the present disclosure. In some implementations, the method 800 may be executed by the processor 202 (including the one or more processors), as described in relation to FIGS. 1-7.

In an example implementation, the method 800 may include receiving a user input 802 requesting an image of a predetermined object to be generated. Further, the method 800 may include generating, via a multimodal prompt generating model, an enhanced prompt 804 from the user input. For example, the enhanced prompt may include one or more of a reference image of the predetermined object and a textual portion describing technical details for generating the image. In an aspect, a style for the image to be generated is identified based on a brief textual description in the user input. Further, one or more prompt templates are generated with style tags matching the style from a database of prompt templates. For example, the one or more prompt templates may include technical details for the image generation. In an aspect, the prompt templates may be retrieved by filtering out disallowed prompt templates from the database of prompt templates based on content rules provided in the user input. Furthermore, the textual portion of the enhanced prompt is generated by adding the technical details to the brief textual description received in the user input.

Furthermore, the method 800 may include inputting the enhanced prompt to an image generation model 806 that preserves portions of the reference image including the predetermined object unchanged via masking the portions of the reference image, generates a depth map of the reference image, and generates an intermediate image by merging the reference image with the masked portions of the predetermined object and the depth map. In an aspect, the depth map may enable positioning of the predetermined object in the image to be generated.

In some examples, the method 800 may include training the image generation model. In an example implementation, for training the image generation model, the method 800 includes freezing pre-trained model weights of parameters of the image generation model. Further, the method 800 may include injecting trainable rank decomposition weights into each layer of a transformer of the image generation model.

Also, the method 800 may include outputting 808 an enhanced version of the intermediate image as the image generated in response to the user input. In an aspect, shadows of the predetermined object are generated in the intermediate image using the image generation model.

In some examples, the method 800 may include generating by the processor, the reference image as an output of the multimodal prompt generating model based on brief textual description included in the user input.

Implementations of the present disclosure may translate vague or high-level user inputs into structured, model-compatible prompts using LLMs and curated prompt templates, eliminating the need for users to understand or write model-specific syntax. Further, by incorporating design guidance and filtering prompt templates using allowed and disallowed styles, the Gen AI-based system may ensure stylistic consistency and compliance in the generated outputs without requiring manual review.

Also, the use of the segmentation model and the depth estimation model may allow the Gen AI-based system to precise masking and layout guidance during image generation, ensuring that reference objects (e.g., products or human figures) are preserved in position and form, even as backgrounds or surrounding elements are modified. Furthermore, integration of the control network may enable fine-grained spatial conditioning, allowing the Gen AI-based system to generate images with precise object placement and scene structure. Moreover, the system supports lightweight model tuning, enabling rapid incorporation of new visual elements or brand-specific features into large generative models without retraining the entire network. Therefore, by using prompt enhancement, masking, and depth-based conditioning, the Gen AI-based system significantly reduces the probability of generating semantically inconsistent or visually unrealistic images, thus enhancing the overall reliability of outputs.

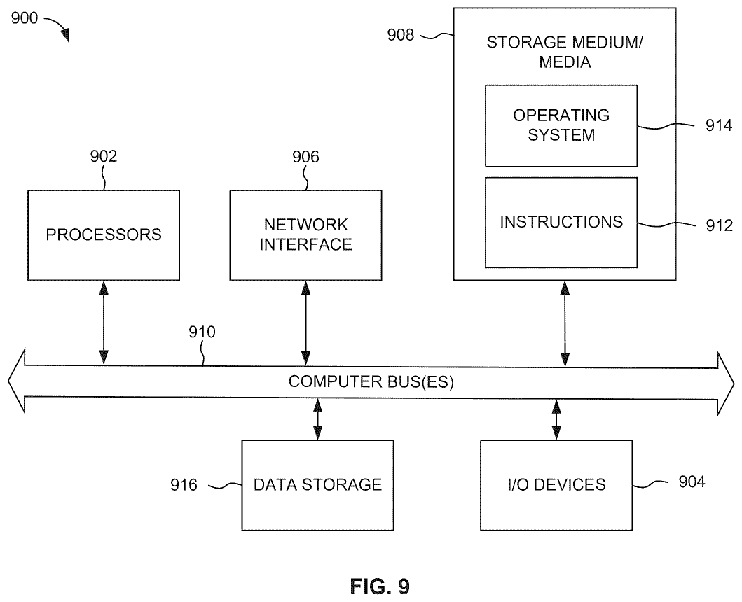

FIG. 9 illustrates a computer system 900 (i.e., the Gen AI-based image generation system 104) that may be used to implement the method for generating data visualizations using LLMs, in accordance with implementations of the present disclosure. More particularly, computing machines such as desktops, laptops, smartphones, tablets, and wearables which may be used to perform the software testing. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, etc., a network interface 906, such as a Local Area Network (LAN), a wireless 902.11x LAN, a 3G or 4G mobile WAN or a WiMax WAN, and a computer-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the methods and functions of the system 104.

The system 900 may be implemented as software stored on a non-transitory processor-readable medium and executed by the processor(s) 902. For example, the computer-readable medium 908 may store an operating system 914, such as MAC OS, MS WINDOWS, UNIX, or LINUX, and code, for the system 900. The operating system 914 may be multi-user, multiprocessing, multitasking, multithreading, real-time, and the like. For example, during runtime, the operating system 914 is running and the code for the computer system 900 is executed by the processor(s) 902.

The computer system 900 may include a data storage 916, which may include non-volatile data storage. The data storage 916 stores any data used or generated by the system 104.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet. The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A Generative Artificial Intelligence (Gen AI)-based image generation system, comprising:
at least one hardware processor; and
at least one non-transitory processor-readable medium storing instructions to be executed by the at least one hardware processor to:
receive a user input requesting an image of a predetermined object to be generated;
generate via a multimodal prompt generating model, an enhanced prompt from the user input,
wherein the enhanced prompt includes one or more of a reference image of the predetermined object and a textual portion describing technical details for generating the image;
input the enhanced prompt to an image generation model that:
preserves portions of the reference image including the predetermined object, unchanged via masking the portions of the reference image;
generates a depth map of the reference image that positions the predetermined object in the image to be generated; and
generates an intermediate image by merging the masked portions of the predetermined object and the depth map; and
output an enhanced version of the intermediate image as the image generated in response to the user input.

2. The Gen AI system of claim 1, wherein the user input includes at least one of an input image and a brief textual description of the image to be generated.

3. The Gen AI system of claim 2, wherein to generate the enhanced prompt the at least one non-transitory processor-readable medium stores further instructions that cause the at least one hardware processor to:
identify a style for the image based on the brief textual description from the user input;
retrieve one or more prompt templates with style tags matching the style from a database of prompt templates,
wherein the one or more prompt templates include the technical details for the image generation; and
generate the textual portion of the enhanced prompt by adding the technical details to the brief textual description received in the user input.

4. The Gen AI system of claim 3, wherein the details included in the prompt templates include one or more technical details of the image.

5. The Gen AI system of claim 3, wherein to retrieve the one or more prompt templates the at least one non-transitory processor-readable medium stores further instructions that cause the at least one hardware processor to:
access a database of prompt templates and content rules specifying allowed styles and disallowed styles; and
filter the prompt templates of the database based on the allowed styles and disallowed styles to retrieve the one or more prompt templates.

6. The Gen AI system of claim 2, wherein to generate the enhanced prompt the at least one non-transitory processor-readable medium stores further instructions that cause the at least one hardware processor to:
provide the input image to the multimodal prompt generating model, and
receive a textual description of the input image as output from the prompt generating model when the user input includes the input image.

7. The Gen AI system of claim 1, wherein the image generation model includes a segmentation model that masks the portions of the reference image including the predetermined object.

8. The Gen AI system of claim 1, wherein the image generation model includes a depth estimation model that generates the depth map of the reference image,
wherein the depth map provides a layout for positioning the predetermined object in the image to be generated.

9. The Gen AI system of claim 8, wherein to generate the intermediate image the at least one non-transitory processor-readable medium stores further instructions that cause the at least one hardware processor to:
input the depth map to a control network included in the image generation model, wherein the control network positions the predetermined object in the image by guiding image generation along the layout provided by the depth map.

10. The Gen AI system of claim 9, wherein to output the enhanced version of the intermediate image the at least one non-transitory processor-readable medium stores further instructions that cause the at least one hardware processor to:
provide output of the control network and the reference image with the masked portions to an image-to-image generation model within the image generation model.

11. The Gen AI system of claim 10, wherein to output the enhanced version of the intermediate image, at least one non-transitory processor-readable medium stores further instructions that cause the at least one hardware processor to:
execute the image-to-image generation model that adds noise to the reference image while keeping the masked portions of the reference image unchanged.

12. The Gen AI system of claim 1, wherein to output the enhanced version of the intermediate image the at least one non-transitory processor-readable medium stores further instructions that cause the at least one hardware processor to:
enhance an output from the image-to-image generation model via adding shadows; and
provide the enhanced version of the intermediate image with the shadows as the image generated in response to the user input.

13. A processor-executable method comprising:
receiving, by a processor, a user input requesting an image of a predetermined object to be generated;
generating, by the processor, via a multimodal prompt generating model, an enhanced prompt from the user input,
wherein the enhanced prompt includes one or more of a reference image of the predetermined object and a textual portion describing technical details for generating the image;
inputting, by the processor, the enhanced prompt to an image generation model that:
preserves portions of the reference image including the predetermined object unchanged via masking the portions of the reference image;
generates a depth map of the reference image,
wherein the depth map enables positioning of the predetermined object in the image to be generated; and
generates an intermediate image by merging the reference image with the masked portions of the predetermined object and the depth map; and
outputting, by the processor, an enhanced version of the intermediate image as the image generated in response to the user input.

14. The processor-executable method of claim 13, further comprising:
generating by the processor, the reference image as an output of the multimodal prompt generating model based on brief textual description included in the user input.

15. The processor-executable method of claim 13, further comprising:
training, by the processor, the image generation model via steps including:
freezing, by the processor, pre-trained model weights of parameters of the image generation model; and
injecting, by the processor, trainable rank decomposition weights into each layer of a transformer of the image generation model.

16. The processor-executable method of claim 13, wherein generating the enhanced prompt further comprises:
identifying, by the processor, a style for the image to be generated based on a brief textual description in the user input;
retrieving, by the processor, one or more prompt templates with style tags matching the style from a database of prompt templates,
wherein the one or more prompt templates include technical details for the image generation; and
generating, by the processor, the textual portion of the enhanced prompt by adding the technical details to the brief textual description received in the user input.

17. The processor-executable method of claim 16, wherein retrieving the prompt templates further comprises:
filtering out, by the processor, disallowed prompt templates from the database of prompt templates based on content rules provided in the user input.

18. The processor-executable method of claim 13, wherein outputting the enhanced version of the intermediate image comprises:
generating, by the processor via the image generation model, shadows of the predetermined object in the intermediate image.

19. A non-transitory processor-readable storage medium comprising processor-readable instructions that cause a processor to:
receive a user input requesting an image of a predetermined object to be generated;
generate via a multimodal prompt generating model, an enhanced prompt from the user input,
wherein the enhanced prompt includes one or more of a reference image of the predetermined object and a textual portion describing technical details for generating the image;
input the enhanced prompt to an image generation model that:
preserves portions of the reference image including the predetermined object unchanged via masking the portions of the reference image;
generates a depth map of the reference image that positions the predetermined object in the image to be generated; and
generates an intermediate image by merging the reference image with the masked portions of the predetermined object and the depth map; and
output an enhanced version of the intermediate image as the image generated in response to the user input.

20. The non-transitory processor-readable storage medium of claim 19, wherein instructions to generate the intermediate image further comprise instructions that cause the processor to:
receive a preliminary image of the predetermined object in the user input; and
generate the intermediate image with a background from the reference image superimposed with the preliminary image of the predetermined object in a foreground.
